(19) United States
(12) Patent Application Publication
(10) Pub. No.: US 2019/0341166 A1
(43) Pub. Date: Nov. 7, 2019

(54) VEHICLE WIRING

(71) Applicant: International Truck Intellectual Property Company, LLC, Lisle, IL (US)

(72) Inventor: Mark Lill, Elgin, IL (US)

(73) Assignee: International Truck Intellectual Property Company, LLC, Lisle, IL (US)

(21) Appl. No.: 15/969,925

(22) Filed: May 3, 2018

(51) Int. Cl. H01B 7/02; B60R 16/02; B60R 16/03

(52) U.S. Cl. CPC H01B 7/02; B60R 16/03; B60R 16/02

(57) ABSTRACT

Embodiments disclosed herein comprise wiring for a vehicle including a frame rail and a functional element. In one embodiment, the wiring comprises an electrically conductive substance disposed proximate to the frame rail of the vehicle. An electrically insulating foam encompasses the electrically conductive substance. A conductor is ultrasonically welded between the electrically conductive substance and the functional element.

### U.S. GOVERNMENT RIGHTS

This invention was made with U.S. Government support under the U.S. Department of Energy EERE Award No. DE-EE-0007767. The U.S. Government has certain rights in this invention

### BACKGROUND

A vehicle may comprise an electric system that provides electric energy to functional elements of the vehicle. In some vehicles, the electric system may include metal wiring. This metal wiring may be made of copper. Copper wiring may add significantly to weight and to cost of the vehicle. Increased weight of a vehicle often increases energy, viz. fuel, needed to move the vehicle. Accordingly, it is desirable to provide a vehicle with an electric system comprising wiring that is less expensive and weighs less than copper wiring.

### SUMMARY

Embodiments disclosed herein comprise wiring for a vehicle including a bus bar, a frame rail and a set of functional devices. In one embodiment, the wiring comprises an electrically conductive substance disposed proximate to the frame rail of the vehicle. An electrically insulating foam encompasses the electrically conductive substance. A conductor is ultrasonically welded between the electrically conductive substance and the functional device.

### DETAILED DESCRIPTION

Embodiments disclosed herein comprise vehicle wiring consisting of an electrically conductive substance that weighs less than copper. In some embodiments, the electrically conductive substance comprises aluminum. In other embodiments, the electrically conductive substance comprises an electrically conductive composite. In some embodiments, the electrically conductive substance is disposed proximate to a structural member of the vehicle. In these embodiments, the electrically conductive substance may be routed and clipped to the structural member, for instance, to reduce tension on the electrically conductive substance. The electrically conductive substance may be disposed within a convolute surrounded by electrically insulating foam. In other embodiments, such as with a truck, the electrically conductive substance is disposed proximate to a frame rail of the truck. In some embodiments, there may be multiple pieces of the electrically conductive substance.

Use of some embodiments, such as with transportation vehicles, the electrically conductive substance may be exposed to a force that can compromise the electrically conductive substance. For instance, the force may comprise vibration of the vehicle. Vibration of the vehicle may cause stress cracking of the electrically conductive substance. This may be of particular concern if the electrically conductive substance is aluminum. To combat this vibration, the electrically conductive substance can be enclosed in an electrically insulating foam. This foam may be disposed along substantially an entire length of the electrically conductive substance on the vehicle. In some embodiments, the foam can join the electrically conductive substance to a portion, such as a corner opposing a truck bottom, of the truck frame rail.

In some embodiments, it may be desirable to electrically connect a functional element, such as, but not limited to, a battery, a drive motor, a steering pump, a cooling pump, an HVAC fan, an HVAC pump, a solar panel, an air pump, a braking system and a radiator fan, of the vehicle. To make an electrical connection between the electrically conductive substance and the functional element, a conductor can be ultrasonically welded between the electrically conductive substance and the functional element. Ultrasonic welding may reduce formation of metal oxidation that can lead to increased electrical resistance at a weld. The conductor may comprise any appropriate material, such as copper and the like.

What is claimed is:

1. Wiring for a vehicle including a frame rail and a functional element, the wiring comprising:
an electrically conductive substance disposed proximate to the frame rail of the vehicle;
an electrically insulating foam encompassing the electrically conductive substance; and
a conductor ultrasonically welded between the electrically conductive substance and the functional element.

2. Wiring as defined in claim 1 wherein the functional element includes at least one of a battery, a drive motor, a steering pump, a cooling pump, an HVAC fan, an HVAC pump, a solar panel, an air pump, a braking system and a radiator fan.

3. Wiring as defined in claim 1 wherein the electrically conductive substance includes at least one of aluminum and a conductive composite.

4. Wiring as defined in claim 1 wherein the electrically conductive substance has a length and the electrically insulating foam surrounds the electrically conductive substance along the length.

5. Wiring as defined in claim 4 wherein the electrically insulating foam joins the electrically conducive substance to the frame rail.

6. Wiring as defined in claim 5 wherein the electrically insulating foam is enclosed in a nonconductive and protective material.

7. Wiring as defined in claim 6 wherein the nonconductive and protective material comprises a convolute.
